(19) United States
(12) Patent Application Publication
(10) Pub. No.: US 2013/0119750 A1
(43) Pub. Date: May 16, 2013

(54) WHEEL HUB FOR A MOTOR VEHICLE

(71) Applicants: Klaus Greven, Hildesheim (DE); Manikandan Loganathan, Hildesheim (DE)

(72) Inventors: Klaus Greven, Hildesheim (DE); Manikandan Loganathan, Hildesheim (DE)

(73) Assignee: KSM CASTINGS GROUP GMBH, Hildesheim (DE)

(21) Appl. No.: 13/812,022

(22) PCT Filed: Sep. 8, 2011
(86) PCT No.: PCT/DE2011/001701

§ 371 Date: Jan. 24, 2013

(30) Foreign Application Priority Data
Sep. 14, 2010 (DE) 10 2010 045 324.2
Mar. 18, 2011 (DE) 10 2011 014 485.4

(51) Int. Cl. B60B 27/00; B22D 18/06

(52) U.S. Cl. CPC B60B 27/001; B22D 18/06
USPC 301/110; 164/61

(57) ABSTRACT

The invention relates to a wheel hub for a motor vehicle. The wheel hub has a basic hub body, a wheel flange which has a plurality of threaded holes for accommodating wheel screws for attaching a wheel rim, and a bearing, particularly a roller bearing which is disposed or is to be disposed in the basic hub body. The basic hub body is produced, at least in part, by casting of material around the bearing or its outer bearing ring, or by casting of material around a part of the basic hub body that is already in existence, using the die-cast method.

The invention relates to a wheel hub for a motor vehicle.

Known wheel hubs have already been disclosed, for example, in DE 10 2005 052 479 or DE 10 2007 060629 A1, and comprise a basic hub body having a wheel flange, which are usually configured in one piece. While the basic hub body is configured for accommodating a corresponding bearing, for example, particularly a roller bearing, the wheel flange comprises a plurality of threaded holes that serve for accommodating wheel screws for attaching a wheel rim.

From DE 33 33 506 C2, it is known to introduce a complete bearing, particularly a roller bearing, into a casting mold, and to cast light metal around it, to form the basic hub body.

Proceeding from this state of the art, the invention is based on the task of indicating a wheel hub for a motor vehicle that can be produced in simpler and more cost-advantageous manner, permits a greater configuration possibility and greater configuration freedom, and is configured to be more weight-optimized, while simultaneously demonstrating great load-bearing capacity.

This task is accomplished, according to the invention, by means of a wheel hub having the characteristics of claim 1. Advantageous embodiments with practical and non-trivial further developments of the invention are indicated in the remaining claims.

The wheel hub for a motor vehicle, according to the invention, comprises a basic hub body having a wheel flange, which has a plurality of threaded holes for accommodating wheel screws, in particular, for attaching a wheel rim. The wheel hub furthermore comprises a bearing, particularly a roller bearing, which is disposed or is to be disposed in the basic hub body. According to the invention, the basic hub body is produced, at least in part, by means of casting of material around the bearing or its outer bearing ring, or preferably by casting of material around a part of the basic hub body that is already in existence, using the die-casting method.

The wheel hub according to the invention is optimized with regard to material use, and therefore is relatively light.

Contrary to a long-felt prejudice in the technical field, the bearing or its outer bearing ring or a part of the basic hub body in which the bearing is disposed or to be disposed can have a light metal cast around it, in remarkably simple manner, using the die-casting method, to form or preferably to complete the basic hub body, whereby the formation of the part of the wheel hub around which material is to be cast, which is composed of steel or iron, does not represent a reason not to do so, contrary to expectations. It has turned out that the part of the basic hub body produced using the die-casting method represents optimal local reinforcement of the wheel hub, which includes improved load-bearing capacity of the wheel hub as a whole.

A further development of the invention accordingly provides that the part of the basic hub body produced using the die-casting method, by means of casting of material around the body, consists of a light metal, preferably of an aluminum or magnesium alloy.

A particularly advantageous embodiment of the invention provides that the part of the basic hub body produced by means of casting of material around the body is produced using the vacuum die-casting method. In this connection, the use of a vacuum die-casting system or a method according to the German patent application DE 10 2010 046 141.9 is particularly advantageous; its disclosure or content is properly incorporated or integrated into the present application, by means of explicit reference, as belonging to the object of the present application. In this way, a wheel hub having a comparatively thicker wall thickness can particularly be produced, without any porosities occurring, which would disadvantageously lead to blisters during subsequent heat treatment of the wheel hub.

Further details of the invention are evident from the following description, in connection with the drawing. This shows:

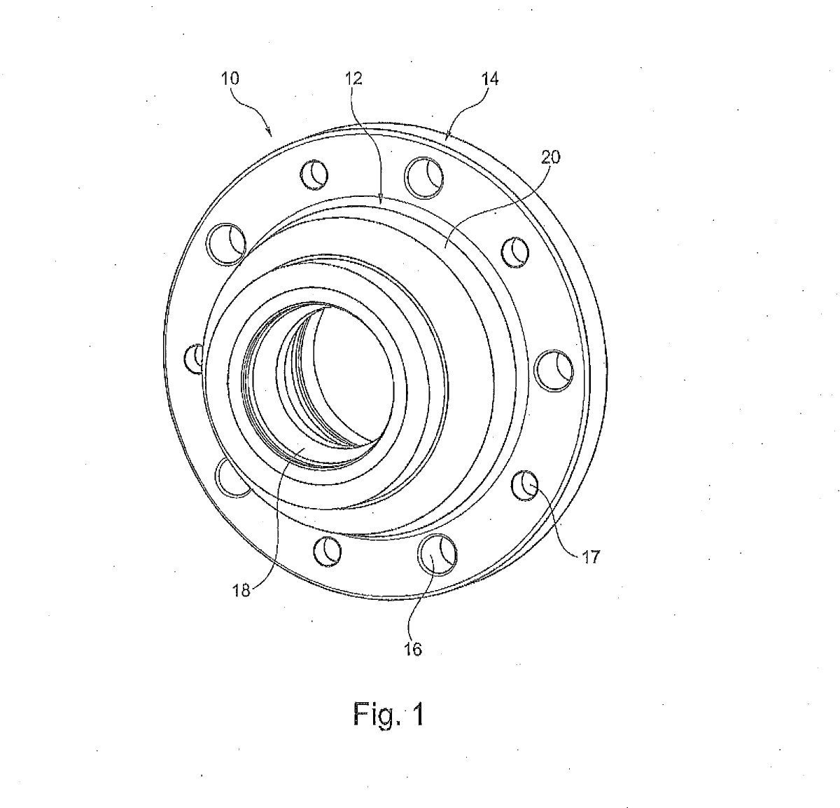

FIG. 1 a perspective view of the wheel hub according to the invention, with a part of the basic hub body produced using the vacuum die-casting method, and

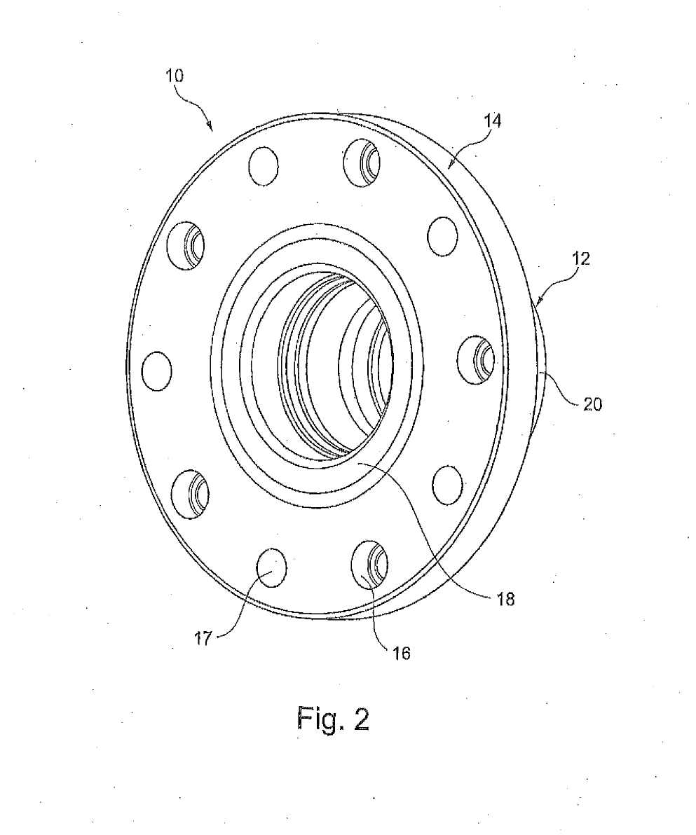

FIG. 2 a perspective view of the wheel hub according to the invention, according to FIG. 1, from a different viewing angle.

FIG. 1 shows a perspective view of a wheel hub 10 for a motor vehicle, having a basic hub body 12 and a wheel flange 14, from a side that faces away from an attachment side of a wheel rim. FIG. 2 shows a perspective view of the wheel hub 10 according to FIG. 1 from the attachment side of the wheel rim. The wheel flange 14 has a plurality of threaded holes 16 for accommodating wheel screws for attaching a wheel rim, as well as further recesses 17 for saving weight.

The wheel hub 10 has a rotation-symmetrical basic hub body 12 and a disk-shaped wheel flange 14 as essential component regions; the flange serves, among other things for fixing a wheel rim of a vehicle wheel in place.

In the present case, a part of the basic hub body 12 and of the wheel flange 14 are configured in one piece, as a steel forged part, whereby this total component can also be referred to. as a bearing ring.

This bearing ring now has a light metal cast around it, according to the invention, using the vacuum die-casting method, in order to optimize weight and for local reinforcement, whereby the cast part 20 becomes part of the basic hub body 12. As a result, material for forming the bearing can be saved. The vacuum die-casting method has proven to be particularly suitable for forming a part 20 of the basic hub body 12, contrary to a prejudice that has long been held in the technical field.

The basic hub body 12 and the wheel flange 14 can also be formed separately, if necessary, and joined together accordingly.

1. Wheel hub (10) for a motor vehicle, having a basic hub body (12) and having a wheel flange (14), which has a plurality of threaded holes (16) for accommodating wheel screws for attaching a wheel rim, as well as having a bearing (18), particularly a roller bearing, which is disposed or is to be disposed in the basic hub body (12), wherein the basic hub body (12) is produced, at least in part, by casting of material around the bearing (18) or its outer bearing ring, or by casting of material around a part of the basic hub body (12) that is already in existence, using the die-casting method.

2. Wheel hub, particularly according to claim 1, wherein the part (20) of the basic hub body (12) produced using the die-casting method, by means of casting of material around the body, consists of a light metal, preferably of an aluminum or magnesium alloy.

3. Wheel hub, particularly according to claim 1, wherein the part (20) of the basic hub body (12) produced by means of casting of material around the body is produced using the vacuum die-casting method.
